(19) United States
(12) Patent Application Publication
(10) Pub. No.: US 2011/0174952 A1
(43) Pub. Date: Jul. 21, 2011

(54) DISPLAY DEVICE AND STAND THEREOF

(76) Inventors: Guo-Ting Huang, TAIPEI CITY (TW); Chien-Chen Lin, TAIPEI CITY (TW); Chih-Ming Fan, TAIPEI CITY (TW)

(21) Appl. No.: 13/007,659

(22) Filed: Jan. 16, 2011

(30) Foreign Application Priority Data
Jan. 18, 2010 (TW) 099101232

(51) Int. Cl. F16M 11/22

(52) U.S. Cl. 248/371

(57) ABSTRACT

A display device includes a display module and a stand. The display module has a display surface. The stand includes a curved sliding rail, a base, and a holder. The curved sliding rail is fixed to the display module. The base is suitable for being disposed at the supporting surface. The holder is slidably connected with the curved sliding rail and is pivotally connected with the base. By rotating of the holder relative to the base and sliding of the holder along the curved sliding rail, an angle between the display surface and the supporting surface and a distance between the display surface and the supporting surface are adjustable.

### CROSS-REFERENCE TO RELATED APPLICATIONS

This Non-provisional application claims priority under 35 U.S.C. §119(a) on Patent Application No(s). 099101232 filed in Taiwan, Republic of China on Jan. 18, 2010, the entire contents of which are hereby incorporated by reference.

### BACKGROUND OF THE INVENTION

1. Field of the Invention

This invention relates to an electronic device and a stand thereof and, more particularly, to a display device and a stand thereof.

2. Description of the Related Art

At present, flat panel displays are the mainstream of displays. Since the flat panel displays have small sizes and are light and thin, generally should be erected at a table by stands. In detail, the stand may include a base suitable for being disposed at the table top and a holder connected between the base and the display.

FIG. 1 is a schematic diagram showing a conventional display device. FIG. 2 is a schematic diagram showing operation of the display device in FIG. 1. In FIG. 1, to allow a user to be capable of adjusting a height and an angle of a display module, a holder 52 is usually pivotally disposed at a base 54 and a display module 56 is slidably disposed at the holder 52, thus to adjust the angle of the display module 56 by rotating of the holder 52 relative to the base 54 along a direction D1 and to adjust the height of the display module 56 by movement of the display module 56 relative to the holder 52 along a direction D2.

When the holder 52 is pivoted relative to the base 54 along the direction D1 as shown in FIG. 2, a center of gravity of the holder may change. To prevent the display device 50 from being turned over due to change of the center of gravity, the base 54 needs to have an adequate width L1. However, the base 54 with a large size may occupy a using area of a table top, and manufacturing costs may increase.

### BRIEF SUMMARY OF THE INVENTION

This invention provides a display device capable of keeping balance of the whole structure by a smaller base.

The invention provides a stand, and a display device using the same keep balance of the whole structure by a smaller base.

The invention provides a display device including a display module and a stand. The display module has a display surface. The stand includes a curved sliding rail, a base, and a holder. The curved sliding rail is fixed to the display module. The base is suitable for being disposed at the supporting surface. The holder is slidably connected with the curved sliding rail and is pivotally connected with the base. By rotating of the holder relative to the base and sliding of the holder along the curved sliding rail, an angle and a distance between the display surface and the supporting surface are adjustable.

The invention provides a stand suitable for being used in a display device. The display device includes a display module. The display module has a display surface. The stand includes a curved sliding rail, a base, and a holder. The curved sliding rail is fixed to the display module. The base is suitable for being disposed at the supporting surface. The holder is slidably connected with the curved sliding rail and is pivotally connected with the base. By rotating of the holder relative to the base and sliding of the holder along the curved sliding rail, an angle and a distance between the display surface and the supporting surface are adjustable.

In one embodiment of the invention, the display module may include a shell, the shell may have at least one slot, the curved sliding rail may be fixed to the shell, and the holder may pass through the slot to be slidably disposed at the curved sliding rail.

In one embodiment of the invention, the holder rotates relative to the base and the holder slides along the curved sliding rail for driving the bottom of the display module to contact the supporting surface.

In one embodiment of the invention, the bottom of the display module may have a buffering element suitable for contacting the supporting surface.

In one embodiment of the invention, the buffering element may be made of rubber.

In one embodiment of the invention, the stand may further include an elastic element connected between the curved sliding rail and the holder and providing elastic force in a direction opposite to that of gravity to position the holder at the curved sliding rail.

In one embodiment of the invention, a center of curvature of the curved sliding rail and the holder may be located at two sides of the curved sliding rail, respectively.

In one embodiment of the invention, the holder may be pivoted on an axis parallel to the supporting surface.

According to the above, in the invention, the curved sliding rail is fixed to the display module, and the holder is slidably disposed at the curved sliding rail and is pivotally disposed at the base. A user can adjust an angle of the display module by rotating of the holder relative to the base, and he or she can further adjust the angle of the display module by sliding of the holder along the curved sliding rail at the same time. Thereby, compared with the conventional display device, in the invention, the rotating range of the holder of the display device relative to the base can be designed to be smaller, such that when the holder is rotated to the greatest inclined angle relative to the base, the center of gravity of the whole structure may not deviate too much. Therefore, the base can be designed to have a smaller width to keep balance of the whole structure, further to reduce manufacturing costs.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional display device;

FIG. 2 is a schematic diagram showing operation of the display device in FIG. 1;

FIG. 3 is a three-dimensional diagram showing a display device according to one embodiment of the invention;

FIG. 4 is a three-dimensional diagram showing part components of the display device in FIG. 3;

FIG. 5A is a side sectional diagram showing the display device in FIG. 4;

FIG. 5B is a schematic diagram showing operation of the display module in FIG. 5A;

FIG. 6 is an exploded diagram showing the display device in FIG. 3; and

FIG. 7 is a side sectional diagram showing a display device according to another embodiment of the invention.

### DETAILED DESCRIPTION OF THE INVENTION

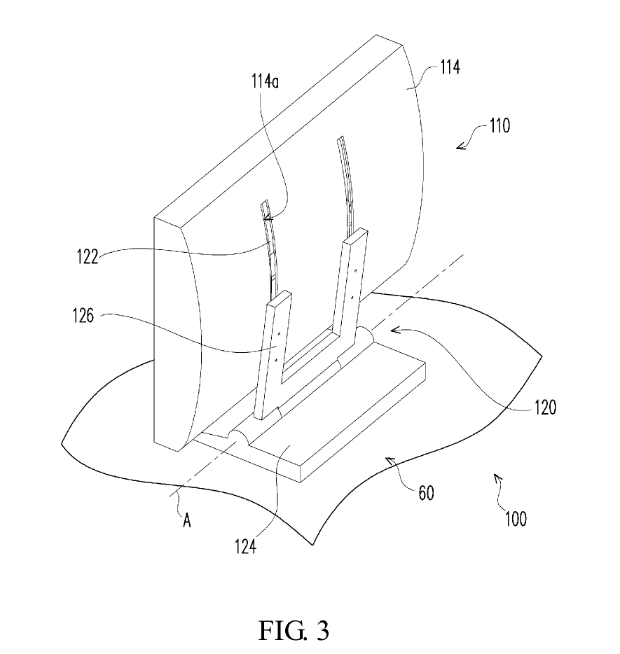

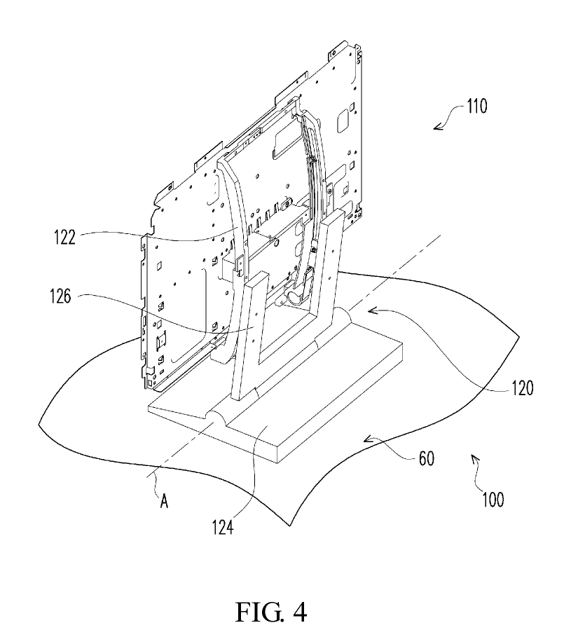

FIG. 3 is a three-dimensional diagram showing a display device according to one embodiment of the invention. FIG. 4 is a three-dimensional diagram showing part components of the display device in FIG. 3. In FIG. 3 and FIG. 4, a display device 100 in the embodiment includes a display module 110 and a stand 120. The stand 120 is used for supporting the display module 110 at a supporting surface 60. In the embodiment, the display device 100 may be a flat display device capable of being used in a personal computer, and the supporting surface 60 may be a common table top.

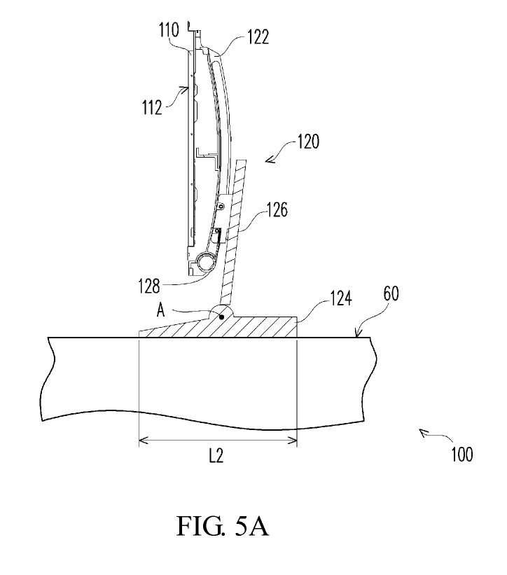

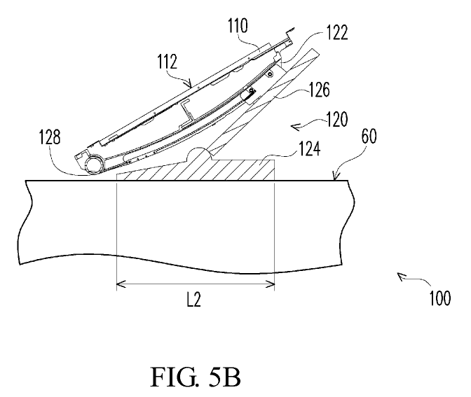

The stand 120 can support the display module 110 at the supporting surface 60, and the stand 120 can further have a function for adjusting a position of the display module 110. The stand 120 includes a curved sliding rail 122, a base 124, and a holder 126. The curved sliding rail 122 is fixed to the display module 110. The base 124 is suitable for being disposed at the supporting surface 60. The holder 126 is slidably connected with the curved sliding rail 122 and is pivotally connected with the base 124 along an axis A parallel to the supporting surface 60. In this way, a user can adjust an inclined angle of the display module 110 by rotating of the holder 126 relative to the base 124, and the user can further adjust the inclined angle of the display module 110 by sliding of the holder 126 along the curved sliding rail 122. The operation is described in detail according to FIG. 5A and FIG. 5B hereinbelow.

FIG. 5A is a side sectional diagram showing the display device in FIG. 4. FIG. 5B is a schematic diagram showing the operation of the display module in FIG. 5A. In FIG. 5A, the display module 110 has a display surface 112 for displaying images for viewing or operation in a touch mode by the user. When the user is to adjust the height and the angle of the display surface 112 relative to the supporting surface 60, a force can be exerted on the display module 110 to allow the holder 126 to pivot relative to the base 124 and to allow the holder 126 to slide along the curved sliding rail 122, thus to adjust the display module 110 to the state as shown in FIG. 5B.

When the holder 126 slides along the curved sliding rail 122, the display module 110 can be driven to lift or drop relative to the supporting surface 60, and the display module 110 can further rotate relative to the supporting surface 60. In FIG. 5A, a center of curvature of the curved sliding rail 122 and the holder 126 are located at two sides of the curved sliding rail 122, respectively. When the curved sliding rail 122 slides relative to the holder 126 thus to drive the display module 110 to slide downward, the angle between the display surface 112 and the supporting surface 60 gradually decreases, thus to allow the display surface 112 to rotate to the inclined state in FIG. 5B by cooperating with the rotating of the holder 126 relative to the base 124, thereby facilitating touch operation of the user.

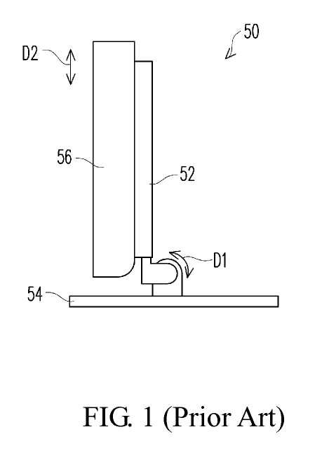

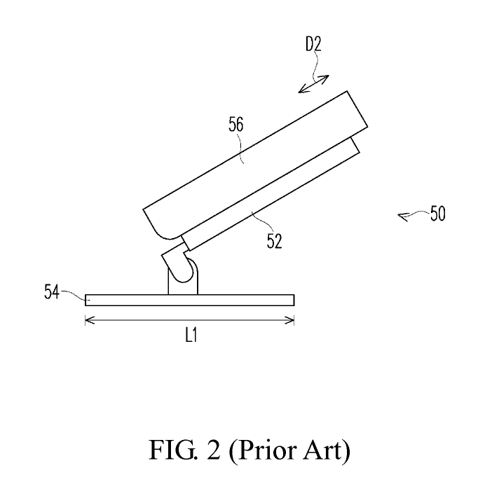

Compared with the conventional display device 50 in FIG. 1 and FIG. 2 in which the angle of the display module 56 is adjusted by the rotating of the holder 52 relative to the base 54, the display device 100 in the embodiment can adjust the angle of the display module 110 by the rotating of the holder 126 relative to the base 124 and the sliding of the holder 126 along the curved sliding rail 122 together. Thereby, the rotating range of the holder 126 relative to the base 124 can be designed to be smaller, such that when the holder 126 is rotated to the greatest inclined angle relative to the base 124, the center of gravity of the whole structure may not deviate too much. Thus, the base 124 can be designed to have a smaller width L2 to be capable of keeping balance of the whole structure, further to reduce manufacturing costs and to prevent the base 124 from occupying too many using areas of the table top, i.e., the supporting surface 60.

For example, in the embodiment, the greatest angle of the display surface 112 sliding relative to the supporting surface 60 by the rotating of the holder 126 relative to the base 124 may be 30 degrees, while the greatest angle of the display surface 112 rotating relative to the supporting surface 60 via the sliding of the holder 126 along the curved sliding rail 122 may be 30 degrees, such that the display device 100 in the embodiment can adjust the inclined angle of the display module 110 in a range of 60 degrees. In other embodiments, the greatest angle of the display surface 112 rotating relative to the supporting surface 60 by the rotating of the holder 126 relative to the base 124 may also be other proper angles which may be greater or less than 30 degrees, and the greatest angle of the display surface 112 rotating relative to the supporting surface 60 by the sliding of the holder 126 along the curved sliding rail 122 may also be other proper angles which may be greater or less than 30 degrees. However, the invention is not limited thereto.

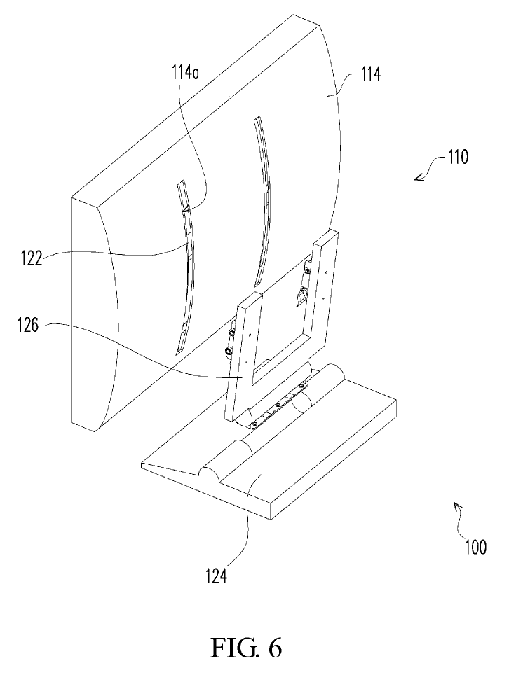

FIG. 6 is an exploded diagram showing the display device in FIG. 3. In FIG. 3 and FIG. 6, in the embodiment, the display module 110 includes a shell 114, and the shell 114 has at least one slot 114a (two are shown). The curved sliding rail 122 is fixed to the shell 114, and the holder 126 passes through the slot 114a to be slidably disposed at the curved sliding rail 122. Since the curved sliding rail 122 is located in the shell 114, the whole thickness of the display module 110 may not increase due to the curved sliding rail 122, such that the display module 110 can have a thinner shape. In FIG. 4, the curved sliding rail 122 can be designed to have a strip-shaped structure which does not occupy space thus to prevent from occupying too much disposition space of the display module 110.

In addition, in FIG. 5A and FIG. 5B, in the embodiment, the stand 120 further includes an elastic element 128. The elastic element 128 is connected between the curved sliding rail 122 and the holder 126 and provides elastic force in a direction opposite to that of gravity to position the holder 126 at the curved sliding rail 122. In detail, when the display module 110 is located at a position as shown in FIG. 5A, the weight of the display module 110 can drive the holder 126 to slide relative to the curved sliding rail 122, and the display module 110 fails to be fixed to the position as shown in FIG. 5A. The elastic element 128 is used for resisting the weight of the display module 110 by the elastic force thereof, thus to position the display module 110.

In the embodiment, the elastic element 128 may be formed by winding a strip-shaped elastic sheet. One end of the strip-shaped elastic sheet is connected with the curved sliding rail 122, and the other end is connected with the holder 126, thus to provide the elastic force between the curved sliding rail 122 and the holder 126 for positioning the display module 110 and to allow the holder 126 and the curved sliding rail 122 to be capable of relatively sliding to the state as shown in FIG. 5B by the tensile characteristic thereof. However, the invention does not limit the type of the elastic element 128. In other embodiments, the elastic element may also be a spring or other proper elastic elements.

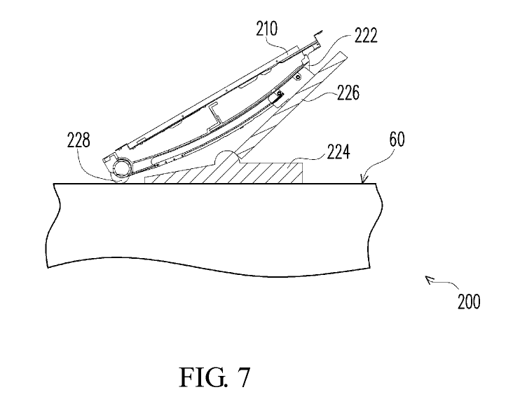

FIG. 7 is a side sectional diagram showing a display device according to another embodiment of the invention. In FIG. 7, compared with the above embodiment in which when the display device 100 is adjusted to the state as shown in FIG. 5B, the bottom of the display module 110 does not contact the supporting surface 60, when a display device 200 in the embodiment is adjusted to the state as shown in FIG. 7, a display module 210 may contact a supporting surface 60. In detail, in the embodiment, a holder 226 rotates relative to a base 224 and slides of the holder 226 along a curved sliding rail 222 for driving the bottom of the display module 210 to contact the supporting surface 60, such that the display module 210 can be stably supported by the supporting surface 60 thus to reduce probability of damage caused by too much force exerted by a user during touch operation. In addition, the bottom of the display module 210 in the embodiment can have a buffering element 228, and the buffering element 228 may be made of rubber for buffering impact force when the display module 210 contacts the supporting surface 60.

To sum up, the curved sliding rail in the invention is fixed to the display module, and the holder is slidably disposed at the curved sliding rail and is pivotally disposed at the base. The user can adjust the angle of the display module by the rotating of the holder relative to the base, and the user can further adjust the angle of the display module by the sliding of the holder along the curved sliding rail at the same time. Thereby, compared with the conventional display device, in the invention, the rotating range of the holder of the display device relative to the base can be designed to be smaller, such that when the holder is pivoted to the greatest inclined angle relative to the base, the center of gravity of the whole structure may not deviate too much. Therefore, the base can be designed to have a smaller width to keep balance of the whole structure, further to reduce manufacturing costs and to prevent the base from occupying too many using areas of the table top.

In addition, the display device can be designed to allow the bottom of the display module to be supported by the table top when the display module is adjusted to the greatest slanted state, thus to reduce the probability of damage caused by too much force exerted by a user during touch operation. Further, the buffering element can be disposed at the bottom of the display module and be used for buffering impact force when the display module contacts the table top. In addition, the curved sliding rail can be disposed in the shell of the display module, thus to allow the display module with the curved sliding rail to be capable of keeping thinner.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A display device comprising:
a display module having a display surface; and
a stand including:
a curved sliding rail fixed to the display module;
a base suitable for being disposed at a supporting surface; and
a holder slidably connected with the curved sliding rail and pivotally connected with the base, an angle and a distance between the display surface and the supporting surface being adjustable by rotating of the holder relative to the base and sliding of the holder along the curved sliding rail.

2. The display device according to claim 1, wherein the display module comprises a shell, the shell has at least one slot, the curved sliding rail is fixed to the shell, and the holder passes through the slot to be slidably disposed at the curved sliding rail.

3. The display device according to claim 1, wherein the holder rotates relative to the base and the holder slides along the curved sliding rail for driving the bottom of the display module to contact the supporting surface.

4. The display device according to claim 3, wherein the bottom of the display module has a buffering element suitable for contacting the supporting surface.

5. The display device according to claim 4, wherein the buffering element is made of rubber.

6. The display device according to claim 1, wherein the stand further comprises an elastic element connected between the curved sliding rail and the holder and providing elastic force in a direction opposite to that of gravity to position the holder at the curved sliding rail.

7. The display device according to claim 1, wherein a center of curvature of the curved sliding rail and the holder are located at two sides of the curved sliding rail, respectively.

8. The display device according to claim 1, wherein the holder is pivoted on an axis parallel to the supporting surface.

9. A stand suitable for being used in a display device, the display device including a display module, the display module having a display surface, the stand comprising:
a curved sliding rail fixed to the display module;
a base suitable for being disposed at a supporting surface; and
a holder slidably connected with the curved sliding rail and pivotally connected with the base, wherein by rotating of the holder relative to the base and sliding of the holder along the curved sliding rail, an angle and a distance between the display surface and the supporting surface are adjustable.

10. The stand according to claim 9, wherein the display module comprises a shell, the shell has at least one slot, the curved sliding rail is fixed to the shell, and the holder passes through the slot to be slidably disposed at the curved sliding rail.

11. The stand according to claim 9, wherein the holder rotates relative to the base and the holder slides along the curved sliding rail for driving the bottom of the display module to contact the supporting surface.

12. The stand according to claim 9, further comprising an elastic element connected between the curved sliding rail and the holder and providing elastic force in a direction opposite to that of gravity to position the holder at the curved sliding rail.

13. The stand according to claim 9, wherein a center of curvature of the curved sliding rail and the holder are located at two sides of the curved sliding rail, respectively.

14. The stand according to claim 9, wherein the holder is pivoted on an axis parallel to the supporting surface.
